(19) United States
(12) Patent Application Publication
(10) Pub. No.: US 2024/0409762 A1
(43) Pub. Date: Dec. 12, 2024

(54) INK SET, AND RECORDING HEAD INSPECTION METHOD

(71) Applicant: KYOCERA Document Solutions Inc., Osaka (JP)

(72) Inventor: Noriaki OZAWA, Osaka-shi (JP)

(73) Assignee: KYOCERA Document Solutions Inc., Osaka (JP)

(21) Appl. No.: 18/676,098

(22) Filed: May 28, 2024

(30) Foreign Application Priority Data
Jun. 7, 2023 (JP) 2023-093583

(51) Int. Cl. C09D 11/38; B41J 29/393; C09D 11/322

(52) U.S. Cl. CPC C09D 11/38; C09D 11/322; B41J 29/393; B41J 2029/3935

(57) ABSTRACT

An ink set includes an inkjet ink and a recording head filling liquid. The inkjet ink contains a pigment, a pigment coating resin, an aqueous medium, a nonionic polymeric surfactant, and a specific glycol ether. The specific glycol ether is triethylene glycol monobutyl ether or diethylene glycol monobutyl ether. The nonionic polymeric surfactant has a mass average molecular weight of at least 6500 and no greater than 10,500. The recording head filling liquid contains a specific moisturizing agent and water.

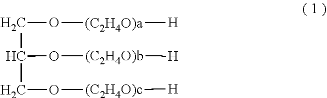

The specific moisturizing agent is a compound represented by general formula (1).

### INCORPORATION BY REFERENCE

The present application claims priority of Japanese Patent Application No. 2023-093583 under 35 U.S.C. § 119, filed on Jun. 7, 2023. The contents of this application are incorporated herein by reference in their entirety.

### BACKGROUND

The present disclosure relates to an ink set and a recording head inspection method.

Inkjet recording apparatuses include a recording head that ejects an inkjet ink. Generally, the recording head is thoroughly inspected for ejection performance and the like before shipping. The recording head is filled with the inkjet ink for an ejection test in the inspection of the ejection performance.

However, the recording head, which is shipped with the inkjet ink remaining in its ink flow channel may have agglomerate of the solids (particularly, the pigment components) of the inkjet ink due to solvent evaporation in the inkjet ink during transportation and storage. The agglomerate causes ejection failure in the shipped recording head.

Therefore, recording head manufacturers may ship the recording head with the recording head filled with a solution that does not contain the pigment components (also referred to below as recording head filling liquid). The recording head filling liquid is required to be capable of being purged from the recording head when it is left unused for a while.

The recording head filling liquid enters the ink flow channel of the recording head and dilutes the inkjet ink remaining in the ink flow channel. Therefore, the recording head filling liquid is also required to be easily introduced into the ink flow channel within the recording head.

For example, a recording head filling liquid is proposed that contains silicone oil.

### SUMMARY

An ink set according to an aspect of the present disclosure includes an inkjet ink and a recording head filling liquid. The inkjet ink contains a pigment, a pigment coating resin, an aqueous medium, a nonionic polymeric surfactant, and a specific glycol ether. The specific glycol ether is a triethylene glycol monobutyl ether or a diethylene glycol monobutyl ether. The nonionic polymeric surfactant has a mass average molecular weight of at least 6500 and no greater than 10,500. The recording head filling liquid contains a specific moisturizing agent and water. The specific moisturizing agent is a compound represented by general formula (1) below.

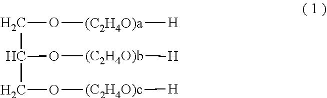

In the general formula (1), a, b, and c each represent, independently of one another, an integer of at least 1 and a+b+c is at least 4 and no greater than 20.

A recording head inspection method according to another aspect of the present disclosure uses the ink set described above and includes: inspecting ejection performance of a recording head; and filling the recording head filling liquid into the recording head after the inspecting. In the inspecting, the ejection performance of the recording head is inspected by causing the recording head to eject the inkjet ink.

### DETAILED DESCRIPTION

The following describes embodiments of the present disclosure. Note that in the following, measurement values for volume median diameter (D₅₀) are values as measured using a dynamic light scattering type particle size distribution analyzer (e.g., “ZETASIZER (registered Japanese trademark) NANO ZS”, product of Malvern Instruments Ltd.) unless otherwise stated.

In the following, measurement values for acid value are values as measured in accordance with the “Japanese Industrial Standards (JIS) K0070-1992” unless otherwise stated. Measurement values for mass average molecular weight (Mw) are values as measured by gel permeation chromatography unless otherwise stated.

In the present specification, the term “(meth)acryl” is used as a generic term for both acryl and methacryl. The expression “at least one of A and B” is synonymous with “either or both A and B”.

### First Embodiment: Ink Set

The following describes an ink set according to a first embodiment of the present disclosure. The ink set of the present embodiment includes an inkjet ink (also referred to below simply as ink) and a recording head filling liquid (also referred to below simply as filling liquid). The ink contains a pigment, a pigment coating resin, an aqueous medium, a nonionic polymeric surfactant, and a specific glycol ether. The specific glycol ether is a triethylene glycol monobutyl ether or a diethylene glycol monobutyl ether. The nonionic polymeric surfactant has a mass average molecular weight of at least 6500 and no greater than 10,500. The filling liquid contains a specific moisturizing agent and water. The specific moisturizing agent is a compound represented by general formula (1) below.

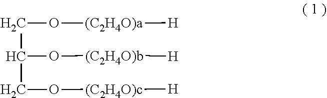

In general formula (1), a, b, and c each represent, independently of each other, an integer of at least 1 and a+b+c is at least 4 and no greater than 20.

The filling liquid, which is included in the ink set of the present embodiment, is used to fill a recording head with an ink remaining therein. For example, when the recording head is going to be left unused for a while for some reason, the filling liquid is used to fill the recording head which has ejected the ink. Specifically, the filling liquid is used to fill the recording head during its shipment, long-term storage, or transportation. The ink set of the present embodiment is preferable to use in the recording head inspection method described in the following second embodiment.

The ink set of the present embodiment, having the features described above, facilitates introduction of the filling liquid into an ink flow channel within a recording head, effectively inhibiting agglomeration of the pigment components (pigment and pigment coating resin) of the ink in the recording head. The filling liquid can also be purged stably from the recording head even after the recording head has been left unused. The reasons for this are inferred to be as follows. The ink set of the present embodiment includes an ink and a filling liquid. The filling liquid enters the ink flow channel of the recording head and dilutes the ink remaining in the ink flow channel. Therefore, solids of the ink remaining in the ink flow channel hardly agglomerate. In particular, the filling liquid of the ink set of the present embodiment contains a specific moisturizing agent with low viscosity. By containing the specific moisturizing agent, the filling liquid is inhibited from thickening even if the water in the filling liquid evaporates. As a result, the filling liquid can effectively inhibit agglomeration of the pigment components (pigment and pigment coating resin) of the ink in the recording head. The filling liquid can also be purged stably from the recording head even after the recording head has been left unused because the pressure (purge pressure) on the recording head does not increase during filling liquid purging. The ink of the ink set of the present embodiment contains a nonionic polymeric surfactant. The nonionic polymeric surfactant can effectively inhibit the pigment components (pigment and pigment coating resin) of the ink from agglomerating in the recording head. In particular, during mixing of the ink and the filing liquid of the ink set of the present embodiment, the pigment components (pigment and pigment coating resin) of the ink can be effectively inhibited from agglomerating, thereby enabling the filling liquid to be introduced smoothly. Moreover, the ink of the ink set of the present embodiment contains a specific glycol ether. The specific glycol ether, which is highly hydrophobic and exhibits excellent wettability, enables the filling liquid to be introduced smoothly during the mixing of the ink and filing liquid.

The following describes the ink set of the present embodiment in more details. Note that each of the components described below may be used alone or in combination of two or more.

### [Ink]

The ink contains a pigment, a pigment coating resin, an aqueous medium, a nonionic polymeric surfactant, and a specific glycol ether. The pigment in the ink constitutes pigment particles together with the pigment coating resin, for example. The pigment particles are dispersed in the aqueous medium. In view of optimizing color density, hue, or stability of the ink, the D₅₀ of the pigment particles is preferably at least 30 nm and no greater than 200 nm, and more preferably at least 70 nm and no greater than 130 nm.

### (Pigment)

Examples of the pigment contained in the ink include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, more specifically 15:3). Examples of the violet pigments include C.I. Pigment Violet (19, 23, or 33). Examples of the black pigments include C.I. Pigment Black (7).

The pigment has a percentage content of preferably at least 2.0% by mass and no greater than 15.0% by mass in the ink, and more preferably at least 5.0% by mass and no greater than 10.0% by mass. Containing the pigment with a percentage content of at least 2.0% by mass facilitates formation of images with desired image density. Containing the pigment with a percentage content of no greater than 15.0% by mass ensures fluidity of the ink.

### (Pigment Coating Resin)

The pigment coating resin is soluble in the ink. A portion of the pigment coating resin is present on the surfaces of the pigment particles to impart the pigment particles with dispersibility, for example. Another portion of the pigment coating resin is present in a dissolved state in the ink, for example.

The pigment coating resin is preferably a styrene-(meth)acrylic resin. The styrene-(meth)acrylic resin includes a styrene unit and a repeating unit derived from at least one monomer of (meth)acrylic acid alkyl ester and (meth)acrylic acid. Examples of the (meth)acrylic acid alkyl ester include methyl (meth)acrylate, ethyl (meth)acrylate, propyl (meth)acrylate, and butyl (meth)acrylate. The styrene-(meth)acrylic resin is preferably a copolymer (X) of styrene, methyl methacrylate, methacrylic acid, and butyl acrylate. Note that the copolymer (X) is preferably neutralized with the equivalent amount of a basic compound (e.g., potassium hydroxide or sodium hydroxide).

In all repeating units included in the copolymer (X), the repeating unit derived from styrene has a percentage content of preferably at least 10.0% by mass and no greater than 20.0% by mass. In all the repeating units included in the copolymer (X), the repeating unit derived from methyl methacrylate has a percentage content of preferably at least 10.0% by mass and no greater than 20.0% by mass. In all the repeating units included in the copolymer (X), the repeating unit derived from methacrylic acid has a percentage content of preferably at least 35.0% by mass and no greater than 45.0% by mass. In all the repeating units included in the copolymer (X), the repeating unit derived from butyl acrylate has a percentage content of preferably at least 25.0% by mass and no greater than 35.0% by mass.

The pigment coating resin has a percentage content of preferably at least 0.7% by mass and no greater than 6.0% by mass in the ink, and more preferably at least 2.0% by mass and no greater than 4.0% by mass. Containing the pigment coating resin with a percentage content of at least 0.7% by mass and no greater than 6.0% by mass can optimize ejection stability of the ink.

The pigment coating resin has an acid value of preferably at least 30 mgKOH/g and no greater than 300 mgKOH/g, and more preferably at least 80 mgKOH/g and no greater than 180 mgKOH/g. Containing the pigment coating resin with an acid value of at least 30 mgKOH/g and no greater than 300 mgKOH/g can optimize both dispersibility of the pigment and preservation stability of the ink.

The acid value of the pigment coating resin can be adjusted by changing the amount of the monomer used in synthesizing the pigment coating resin. For example, in synthesis of the pigment coating resin, using a monomer (specific examples include acrylic acid and methacrylic acid) with an acidic functional group (e.g., a carboxy group) can increase the acid value of the pigment coating resin.

The Mw of the pigment coating resin is preferably at least 10,000 and no greater than 50,000, and more preferably at least 15,000 and no greater than 25,000. Containing the pigment coating resin with an Mw of at least 10,000 and no greater than 50,000 can optimize both image density of formed images and ejection stability of the ink, while inhibiting ink viscosity from increasing.

The Mw of the pigment coating resin can be adjusted by changing conditions (specific conditions includes the amount of a polymerization initiator used, polymerization temperature, and polymerization time) for polymerization of the pigment coating resin.

In polymerization of the pigment coating resin, the amount of the polymerization initiator used is preferably at least 0.001 mol and no greater than 5 mol relative to 1 mol of a monomer mixture, and more preferably at least 0.01 mol and no greater than 2 mol. For example, in polymerization of the pigment coating resin, the polymerization temperature can be set within a range of at least 50° C. to no greater than 70° C. and the polymerization time can be set within a range of at least 10 hours to no greater than 24 hours. Note that the polymerized pigment coating resin is preferably used as the ink material after being neutralized with the equivalent amount of a basic compound. The basic compound is preferably a hydroxide of alkali metal ion (e.g., potassium hydroxide or sodium hydroxide).

### (Aqueous Medium)

The aqueous medium contained in the ink contains water. The aqueous medium may function as either the solvent or the dispersion medium. An example of the aqueous medium is an aqueous medium that contains water and a water-soluble organic solvent.

The aqueous medium has a percentage content of preferably at least 70.0% by mass and no greater than 96.0% by mass in the ink, and more preferably at least 80.0% by mass and no greater than 92.0% by mass.

### (Water)

The water is the main solvent of the ink. The water has a percentage content of preferably at least 20.0% by mass and no greater than 93.0% by mass in the ink, and more preferably at least 50.0% by mass and no greater than 87.0% by mass, for example.

### (Water-Soluble Organic Solvent)

Preferably, the ink further contains a water-soluble organic solvent. Examples of the water-soluble organic solvent contained in the ink include glycol compounds, glycol ether compounds other than the specific glycol ether, lactam compounds, nitrogen-containing compounds, acetate compounds, thiodiglycol, glycerin, and dimethyl sulfoxide.

Examples of the glycol compounds include ethylene glycol, 1,3-propanediol, propylene glycol, 1,5-pentanediol, 1,2-octanediol, 1,8-octanediol, 3-methyl-1,5-pentanediol, diethylene glycol, triethylene glycol, and tetraethylene glycol.

Examples of the glycol ether compounds other than the specific glycol ether include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, and propylene glycol monomethyl ether.

Examples of the lactam compounds include 2-pyrrolidone and N-methyl-2-pyrrolidone.

Examples of the nitrogen-containing compounds include 1,3-dimethylimidazolidinone, formamide, and dimethylformamide.

An Example of the acetate compounds is diethylene glycol monoethyl ether acetate.

Preferably, the water-soluble organic solvent contained in the ink is 2-pyrrolidone or glycerin.

The water-soluble organic solvent has a percentage content of preferably at least 8.0% by mass and no greater than 60.0% by mass in the ink, and more preferably at least 20.0% by mass and no greater than 45.0% by mass. Containing the water-soluble organic solvent with a percentage content of at least 8.0% by mass and no greater than 60.0% by mass can optimize ejection stability of the ink.

When the ink contains 2-pyrrolidone as the water-soluble organic solvent, the 2-pyrrolidone has a percentage content of preferably at least 1.5% by mass and no greater than 12.5% by mass in the ink, and more preferably at least 4.0% by mass to no greater than 9.0% by mass.

When the ink contains glycerin as the water-soluble organic solvent, the glycerin has a percentage content of preferably at least 6.0% by mass and no greater than 50.0% by mass in the ink, and more preferably at least 16.0% by mass and no greater than 36.0% by mass.

### (Nonionic Polymeric Surfactant)

The nonionic polymeric surfactant has a mass average molecular weight of preferably at least 6500 and no greater than 10,500, and more preferably at least 7000 and no greater than 9000. Containing the nonionic polymeric surfactant with amass average molecular weight of at least 6500 and no greater than 10,500 can effectively inhibit the pigment components (pigment and pigment coating resin) from agglomerating in the ink. In other words, it can optimize agglomeration inhibition performance.

An example of the nonionic polymeric surfactant is a copolymer (also referred to below as copolymer (α)) including a repeating unit derived from (meth)acrylic acid polyalkylene glycol alkyl ether and a repeating unit derived from (meth)acrylic acid alkyl ester.

Examples of the (meth)acrylic acid polyalkylene glycol alkyl ether include (meth)acrylic acid polyethylene glycol methyl ethers and (meth)acrylic acid polypropylene glycol methyl ethers. In a (meth)acrylic acid polyethylene glycol methyl ether, the molecular weight of the polyethylene glycol moiety is at least 100 and no greater than 300, for example. In a (meth)acrylic acid polyethylene glycol methyl ether, the molecular weight of the polypropylene moiety is at least 80 and no greater than 150, for example. Preferably, (meth)acrylic acid polyalkylene glycol alkyl ether is polyethylene glycol methyl ether acrylate (PEGA) or polypropylene glycol methyl ether acrylate (PPGA).

The repeating unit derived from (meth)acrylic acid polyalkylene glycol alkyl ether has a percentage content of preferably at least 50.0% by mass and no greater than 90.0% by mass to all repeating units included in the copolymer (a), and more preferably at least 60.0% by mass and no greater than 80.0% by mass.

Examples of (meth)acrylic acid alkyl ester include methyl (meth)acrylate, ethyl (meth)acrylate, propyl (meth)acrylate, butyl (meth)acrylate, hexyl (meth)acrylate, octyl (meth)acrylate, 2-ethylhexyl (meth)acrylate, and lauryl (meth)acrylate. Preferably, (meth)acrylic acid alkyl ester is methyl methacrylate (MMA), lauryl acrylate (LA), butyl acrylate (BA), ethyl acrylate (EA), or lauryl methacrylate (LMA).

The repeating unit derived from (meth)acrylic acid alkyl ester has a percentage content of preferably at least 10.0% by mass and no greater than 50.0% by mass to all repeating units included in the copolymer (a), and more preferably at least 20.0% by mass and no greater than 40.0% by mass.

Preferably, the copolymer (a) is a copolymer including repeating units derived from the monomers of the following Combination (1), or a copolymer including repeating units derived from the monomers of the following Combination (2).
Combination (1): PEGA, BA, PPGA, LA, and MMA
Combination (2): PEGA, EA, PPGA, LMA, and MMA

Preferably, the copolymer (a) includes either Combinations 1 or 2 of the repeating units derived from the monomers shown below in Table 1. Note that, in Table 1 below, “Percentage” column refers to a preferable numerical range of the percentage content [% by mass] of a repeating unit derived from a corresponding monomer. For example, the numerical range of “50.0-70.0”, which is the percentage content range of “PEGA” in Combination 1, indicates that PEGA is contained in a range of at least 50.0% by mass to no greater than 70.0% by mass.

TABLE 1

| Combination | Type of monomer | Percentage |
|---|---|---|
| 1 | PEGA | 50.0-70.0 |
| | BA | 5.0-15.0 |
| | PPGA | 5.0-15.0 |
| | LA | 7.0-17.0 |
| | MMA | 3.0-13.0 |
| 2 | PEGA | 50.0-70.0 |
| | EA | 5.0-15.0 |
| | PPGA | 5.0-15.0 |
| | LMA | 7.0-17.0 |
| | MMA | 3.0-13.0 |

The nonionic polymeric surfactant has a percentage content of preferably at least 0.2% by mass to no greater than 0.9% by mass in the ink, and more preferably at least 0.2% by mass to no greater than 0.4% by mass. Setting the percentage content of the nonionic polymeric surfactant being of at least 0.2% by mass and no greater than 0.9% by mass can further optimize agglomeration inhibition performance.

### (Specific Glycol Ether)

The specific glycol ether contained in the ink is triethylene glycol monobutyl ether or diethylene glycol monobutyl ether.

The specific glycol ether, which is highly hydrophobic and exhibits excellent wettability, enables smooth introduction of the filling liquid during mixing of the ink and filing liquid.

The specific glycol ether has a percentage content of preferably at least 1.0% by mass and no greater than 6.0% by mass in the ink, and more preferably at least 3.0% by mass and no greater than 5.0% by mass. Containing the specific glycol ether with a percentage content of at least 1.0% by mass and no greater than 6.0% by mass can optimize introduction of the filling liquid during mixing of the ink and the filling liquid.

### (Low Molecular Weight Surfactant)

The ink may contain only the nonionic polymeric surfactant as the surfactant, but may further contain a surfactant (also referred to below as additional low molecular weight surfactant) with a smaller molecular weight than that of the nonionic polymeric surfactant. The nonionic polymeric surfactant in the surfactant has a percentage content of preferably at least 40.0% by mass, and more preferably at least 50.0% by mass.

The low molecular weight surfactant may be an acetylene glycol surfactant (surfactant containing an acetylene glycol compound), a silicone surfactant (surfactant containing a silicone compound), or a fluorosurfactant (surfactant containing fluororesin or a fluorine-containing compound), for example. Examples of the acetylene glycol surfactant include ethylene oxide adduct of acetylene glycol and propylene oxide adduct of acetylene glycol. Specific example of the acetylene glycol surfactant is “OLFINE (registered Japanese trademark) E1010” (product of Nissin Chemical Industry Co., Ltd., ethylene oxide adduct of acetylene glycol).

When the ink contains a low molecular weight surfactant, the percentage content of the low molecular weight surfactant is preferably at least 0.1% by mass and no greater than 0.5% by mass, and more preferably at least 0.1% by mass and no greater than 0.3% by mass.

### (Other Components)

The ink may further contain known additives (e.g., a solution stabilizer, an anti-drying agent, an antioxidant, a viscosity modifier, a pH adjuster, and an antifungal agent) as necessary.

### (Preferred Composition)

Preferably, the ink has one of Compositions 1 to 7 shown below in Table 2. Note that, in Table 2 below, “Percentage” column refers to a preferable numerical range of percentage content [% by mass]. For example, the numerical range of “5.0-7.0”, which is the percentage content range of the pigment for Composition 1, indicates that the pigment is contained in a range of at least 5.0% by mass to no greater than 7.0% by mass. “S-1”, “S-3”, “S-4”, and “S-6” as the types of nonionic polymeric surfactantrespectively refer to the surfactants (S-1), (S-3), (S-4), and (S-6) used in Examples. “BTG” refers to triethylene glycol mono-n-butyl ether, and “BDG” refers to diethylene glycol mono-n-butyl ether.

TABLE 2

| | | | | | | | Low | | |
|---|---|---|---|---|---|---|---|---|---|
| | | Pigment | Nonionic | | | | molecular | Aqueous medium | |
| | | coating | polymeric | | Specific | | weight | Water-soluble | |
| | Pigment | resin | surfactant | | glycol ether | | surfactant | organic solvent | Water |
| Composition | Percentage | Percentage | Type | Percentage | Type | Percentage | Percentage | Percentage | Percentage |
| 1 | 5.0-7.0 | 1.8-2.8 | S-1 | 0.2-0.4 | BTG | 2.0-6.0 | 0.1-0.3 | 23.0-27.0 | Rest |
| 2 | 5.0-7.0 | 1.8-2.8 | S-3 | 0.2-0.4 | BTG | 2.0-6.0 | 0.1-0.3 | 23.0-27.0 | Rest |
| 3 | 5.0-7.0 | 1.8-2.8 | S-4 | 0.2-0.4 | BTG | 2.0-6.0 | 0.1-0.3 | 23.0-27.0 | Rest |
| 4 | 5.0-7.0 | 1.8-2.8 | S-6 | 0.2-0.4 | BTG | 2.0-6.0 | 0.1-0.3 | 23.0-27.0 | Rest |
| 5 | 5.0-7.0 | 1.8-2.8 | S-1 | 0.6-0.9 | BTG | 2.0-6.0 | 0.1-0.3 | 23.0-27.0 | Rest |
| 6 | 5.0-7.0 | 1.8-2.8 | S-1 | 0.2-0.4 | BDG | 2.0-6.0 | 0.1-0.3 | 23.0-27.0 | Rest |
| 7 | 5.0-7.0 | 1.8-2.8 | S-1 | 0.2-0.4 | BTG | 1.0-3.0 | 0.1-0.3 | 23.0-27.0 | Rest |

In Compositions 1 to 7 shown in Table 2, the water-soluble organic solvent preferably has the composition shown below in Table 3. Note that, in Table 3 below, “Percentage” column refers to a preferable numerical range of the percentage content [% by mass]. For example, the numerical range of “3.0-7.0”, which is the preferable percentage content [% by mass] range of 2-pyrrolidone, indicates that 2-pyrrolidone is contained in a range of at least 3.0% by mass to no greater than 7.0% by mass.

TABLE 3
Water-solubleorganic solvent

| Type | Percentage |
|---|---|
| 2-Pyrrolidone | 3.0-7.0 |
| Glycerin | 18.0-22.0 |

### (Ink Production Method)

The ink can be produced by uniformly mixing a pigment dispersion containing the pigment, the aqueous medium, the nonionic polymeric surfactant, and the specific glycol ether using a stirrer, for example. In ink production, after each component is mixed uniformly, foreign matter and coarse particles may be removed using a filter (e.g., a filter with a pore size of no greater than 5 μm). The pigment dispersion contains the pigment, the pigment coating resin, and the aqueous medium. The pigment dispersion may further contain the low molecular weight surfactant. The pigment coating resin is prepared by neutralizing an alkali-soluble resin with the equivalent amount of a basic compound (e.g., potassium hydroxide or sodium hydroxide). The pigment dispersion can be prepared by adding the pigment to an aqueous solution containing the pigment coating resin, followed by dispersion treatment. A bead mill is used for dispersion treatment, for example. In ink production, after dispersion treatment, foreign matter and coarse particles may be removed using a filter (e.g., a filter with a pore size of no greater than 5 μm).

### [Filling Liquid]

The filling liquid contains a specific moisturizing agent and water. Note that the filling liquid may further contain a surfactant.

### (Specific Moisturizing Agent)

The specific moisturizing agent is a compound represented by general formula (1) indicated above. In general formula (1), a+b+c is an integer of preferably at least 6 and no greater than 18, and more preferably at least 6 and no greater than 9. The filling liquid, which contains a specific moisturizing agent (e.g., a specific moisturizing agent with a viscosity at 25° C. of no greater than 450 mPa·s) with low viscosity, can be inhibited from thickening even if the water in the filling liquid evaporates. As a result, the filling liquid can effectively inhibit agglomeration of the pigment components (pigment and pigment coating resin) of the ink within the recording head. The filling liquid can also be purged stably from the recording head even after the recording head has been left unused. However, the filling liquid, which contains a specific moisturizing agent with excessively low viscosity, may reduce the dispersibility of the pigment components within the recording head. Allowing a+b+c in general formula (1) to be in a range of at least 4 to no greater than 20 can effectively inhibit agglomeration of the pigment components of the ink within the recording head. Allowing a+b+c in general formula (1) to be in a range of at least 6 to no greater than 18 can further effectively inhibit agglomeration of the pigment components of the ink within the recording head.

The viscosity at 25° C. of the specific moisturizing agent is preferably at least 260 mPa·s and no greater than 450 mPa·s, more preferably at least 330 mPa·s and no greater than 450 mPa·s, and further preferably at least 380 mPa·s and no greater than 440 mPa·s. Containing the specific moisturizing agent with a viscosity of at least 260 mPa·s and no greater than 450 mPa·s can effectively inhibit agglomeration of the pigment components in the ink within the recording head. The filling liquid can also be purged stably from the recording head even after the recording head has been left unused. The measurement values for viscosity of the specific moisturizing agent are values as measured at 25° C. using a falling ball viscometer (e.g., “LOVIS2000”, product of Anton Paar Japan K.K.).

The specific moisturizing agent has a percentage content of preferably at least 16.0% by mass and no greater than 41.0% by mass in the filling liquid, and more preferably at least 25.0% by mass and no greater than 35.0% by mass. Setting the percentage content of the specific moisturizing agent to be at least 16.0% by mass and no greater than 41.0% by mass in the filling liquid can effectively inhibit agglomeration of the pigment components in the ink within the recording head. The filling liquid can also be purged stably from the recording head even after the recording head has been left unused.

### (Surfactant)

Examples of the surfactant in the filling liquid include the same surfactants as those listed as the low molecular weight surfactant in the ink. The surfactant contained in the filling liquid is preferably an acetylene glycol surfactant. The acetylene glycol surfactant improves wettability of the filling liquid to stainless steel, which is often used as the material for the flow channel of the recording head. Therefore, the filling liquid, which contains the acetylene glycol surfactant, is introduced further smoothly into the ink flow channel of the recording head. An example of the acetylene glycol surfactant contained in the filling liquid is “SURFYNOL (registered Japanese trademark) 420” produced by Nissin Chemical Industry Co., Ltd.

The surfactant has a percentage content of preferably at least 0.1% by mass and no greater than 0.5% by mass in the filling liquid, and more preferably at least 0.1% by mass and no greater than 0.3% by mass. The filling liquid, which contains the surfactant with a percentage content of at least 0.1% by mass, is introduced further smoothly into the ink flow channel of the recording head and can effectively inhibit agglomeration of the pigment components in the ink within the recording head. Conversely, an excessive amount of surfactant may reduce dispersibility of the pigment components within the recording head. Therefore, the filling liquid, containing the surfactant with a percentage content of no greater than 0.5% by mass can further effectively inhibit agglomeration of the pigment components in the ink within the recording head.

### (Water)

The water is the main solvent of filling liquid. The water has a percentage content of preferably at least 45.0% by mass and no greater than 95.0% by mass in the filling liquid, and more preferably at least 65.0% by mass and no greater than 85.0% by mass, for example.

### (Other Components)

The filling liquid may further contain known additives (e.g., a solution stabilizer, an anti-drying agent, an antioxidant, a viscosity modifier, a pH adjuster, and an antifungal agent) as necessary.

### (Preferable Composition)

Preferably, the filling liquid has any one of Compositions 1 to 7 shown below in Table 4. Note that, in Table 4 below, “Percentage” column refers to a preferable numerical range of the percentage content [% by mass]. For example, the numerical range of “27.0-33.0”, which is the percentage content range of the specific moisturizing agent in Composition 1, indicates that the specific moisturizing agent is contained in a range of at least 27.0% by mass to no greater than 33.0% by mass. “M-2”, “M-3”, “M-4”, and “M-5” as the types of the specific moisturizing agent respectively refer to the specific moisturizing agents (M-2), (M-3), (M-4), and (M-5) used in Examples.

TABLE 4

| | Specific moisturizing agent | | Surfactant | Water |
|---|---|---|---|---|
| Composition | Type | Percentage | Percentage | Percentage |
| 1 | M-2 | 27.0-33.0 | 0.1-0.3 | Rest |
| 2 | M-3 | 27.0-33.0 | 0.1-0.3 | Rest |
| 3 | M-4 | 27.0-33.0 | 0.1-0.3 | Rest |
| 4 | M-5 | 27.0-33.0 | 0.1-0.3 | Rest |
| 5 | M-2 | 32.0-38.0 | 0.1-0.3 | Rest |
| 6 | M-2 | 18.0-22.0 | 0.1-0.3 | Rest |
| 7 | M-2 | 36.0-44.0 | 0.1-0.3 | Rest |

### (Filling Liquid Production Method)

The filling liquid can be produced by mixing the specific moisturizing agent, water, and a component (e.g., a surfactant) added as necessary, for example. The specific moisturizing agent can be produced through etherification by causing a reaction between polyethylene glycol and glycerin within the temperature range of 180° C. to 220° C.

### Second Embodiment: Recording Head Inspection Method

The following describes a recording head inspection method according to a second embodiment of the present disclosure. The recording head inspection method of the present disclosure uses the ink set according to the first embodiment and includes: an inspection process of inspecting ejection performance of a recording head; and a filling process of filling the recording head filling liquid to the recording head after the inspection process. In the inspection process, the ejection performance of the recording head is inspected by causing the recording head to eject the inkjet ink.

The recording head inspection method of the present embodiment, which uses the ink set according to the first embodiment, can inhibit occurrence of ejection failure in the recording head following inspection. The recording head inspection method of the present embodiment is carried out before shipment of the recording head by a manufacturer, for example. The recording head used in the recording head inspection method of the present embodiment can be any recording head and may be, but not limited to, a piezoelectric inkjet recording head or a thermal inkjet recording head. The recording head is a line recording head, for example.

### [Inspection Process]

In the present process, ejection performance of the recording head is inspected. Specifically, in the present process, the recording head is allowed to eject the ink for inspection of ejection performance. There is ink remaining in the ink flow channel of the recording head inspected by the present process.

In the present process, the recording head may be washed after the inspection. The method for washing the recording head is not limited and may be a method in which a wash fluid is filled into the recording head and then ejected from the recording head, for example. Examples of the wash fluid include water and a wash fluid containing a water-soluble organic solvent. In the present process, it is challenging to completely remove the ink from the ink flow channel of the recording head even through washing.

### [Filling Process]

In the present process, the filling liquid is filled into the recording head. After the present process, the recording head is either stored in preparation for shipping or transported for shipping, for example. After delivered to users, the filling liquid can be expelled from the recording head by ejection.

### Examples

The following describes examples of the present disclosure, but the present disclosure is not limited to the examples.

In Examples, the molecular weights (Mw) of the alkali soluble resin and the nonionic polymeric surfactants were measured using a gel permeation chromatography (“HLC-8020GPC”, product of Tosoh Corporation) under the following conditions. The calibration curve was plotted using n-propylbenzene and TSKgel standard polystyrenes from Tosoh Corporation, including F-40, F-20, F-4, F-1, A-5000, A-2500, and A-1000.

### (Measurement Conditions for Mass Average Molecular Weight)

Column: “TSKGEL SUPERMULTIPOREHZ-H” (semi-micro column with 4.6 mm I.D.×15 cm) produced by Tosoh Corporation
Number of columns: 3
Eluent: tetrahydrofuran
Flow rate: 0.35 mL/min
Sample injection volume: 10 μL
Measurement temperature: 40° C.
Detector: IR detector

### [Examination 1: Type of Moisturizing Agent in Filling Liquid]

First, the type of the moisturizing agent used in the filling liquid was examined. The following is the preparation method of each raw material used in ink production.

### [Pigment Dispersion Preparation]

A pigment dispersion (D-1) was prepared for use in ink production. In the preparation of the pigment dispersion (D-1), a pigment coating resin solution containing a pigment coating resin (R) and water was prepared first.

### (Preparation of Pigment Coating Resin Solution)

An alkali-soluble resin was prepared that included a repeating unit derived from methacrylic acid (MAA unit), a repeating unit derived from methyl methacrylate (MMA unit), a repeating unit derived from butyl acrylate (BA unit), and a repeating unit derived from styrene (ST unit). The alkali-soluble resin had a mass average molecular weight (Mw) of 20,000 and an acid value of 100 mgKOH/g. The mass ratio of each repeating unit in the alkali-soluble resin “MAA unit: MMA unit: BA unit: ST unit” was “40:15:30:15”. The alkali-soluble resin was mixed with a sodium hydroxide aqueous solution (neutralization treatment). Through the neutralization treatment, the alkali-soluble resin was neutralized with NaOH. In the neutralization treatment, the amount of the sodium hydroxide aqueous solution required for neutralizing the alkali-soluble resin was 1.05 times the theoretical value of the amount of the sodium hydroxide aqueous solution. Thus, the alkali soluble resin was neutralized with the equivalent amount (strictly speaking, 105% amount) of sodium hydroxide. As a result, a pigment coating resin solution containing water and a pigment coating resin (R), which is the neutralized alkali-soluble resin, was obtained.

### (Dispersion Treatment)

To achieve the composition shown in below Table 5, a magenta pigment (C.I. Pigment Red 122), the pigment coating resin solution containing the pigment coating resin (R), a surfactant A, and ion exchange water were charged into the vessel of a media type wet disperser (“DYNO (registered Japanese trademark)-MILL”, product of Willy A. Bachofen AG (WAB).

Note that the percentage content of “water” below in Table 5 indicates the total percentage content of water contained in the ion exchange water charged into the vessel and water contained in the pigment coating resin solution. The water contained in the pigment coating resin solution included water contained in the sodium hydroxide aqueous solution used to neutralize the alkali-soluble resin and water generated in the neutralization reaction between the alkali-soluble resin and the sodium hydroxide. The surfactant A was “OLFINE (registered Japanese trademark) E1010” (product of Nissin Chemical Industry Co., Ltd., ethylene oxide adduct of acetylene glycol) being an acetylene glycol surfactant.

TABLE 5

| | Percentage content |
|---|---|
| Pigment dispersion (D-1) | [% by mass] |
| Magenta pigment | 15.0 |
| Pigment coating resin (R) (neutralized with NaOH) | 6.0 |
| Surfactant A | 0.5 |
| Water | 78.5 |
| Total | 100.0 |

The contents of the vessel were then wet dispersed. Zirconia beads (particle diameter 1.0 mm) were used as the medium. The amount of the media charged was 70% by volume relative to the vessel's capacity. The dispersion conditions included a temperature of 10° C. and a circumferential speed of 8 m/sec. The pigment dispersion was thus obtained.

The volume median diameter (D₅₀) of the pigment particles in the resulting pigment dispersion (D-1) was measured. Specifically, the resulting pigment dispersion (D-1) was diluted 300 times with ion exchange water, and the diluted product was used as a measurement sample. The D₅₀ of the pigment particles in the measurement sample was measured using a dynamic light scattering type particle size distribution analyzer (“ZETASIZER (registered Japanese trademark) NANO ZS”, product of Malvern Instruments Ltd.). The D₅₀ of the pigment particles in the measurement sample was used as the D₅₀ of the pigment particles in the pigment dispersion (D-1). Note that the measurement was performed 10 times, and the average value of the measured values was used as the D₅₀ of the pigment particles. The D₅₀ of the pigment particles in the pigment dispersion (D-1) was 100 nm.

### [Preparation of Nonionic Polymeric Surfactant]

A nonionic polymeric surfactant (S-1) was prepared for use in ink production. A copolymer with a mass average molecular weight (Mw) of 8000 was prepared that included a repeating unit derived from polyethylene glycol methyl ether acrylate (molecular weight of polyethylene glycol moiety: 200, PEGA unit), a repeating unit derived from butyl acrylate (BA unit), a repeating unit derived from polypropylene glycol methyl ether acrylate (molecular weight of polypropylene glycol moiety: 100, PPGA unit), a repeating unit derived from lauryl acrylate (LA unit), and a repeating unit derived from methyl methacrylate (MMA unit). The copolymer was used as the nonionic polymeric surfactant (S-1). The mass ratio of each repeating unit in the nonionic polymeric surfactant (S-1) “PEGA unit: BA unit: PPGA unit: LA unit: MMA unit” was 60:10:10:12:8. The nonionic polymeric surfactant (S-1) was soluble in water.

### [Ink Preparation]

### [Preparation of Ink (I-1)]

Ion exchange water was charged into a flask equipped with a stirrer (“THREE ONE MOTOR (registered Japanese trademark) BL-600”, product of Shinto Scientific Co., Ltd.). The pigment dispersion (D-1), the nonionic polymeric surfactant (S-1), triethylene glycol mono-n-butyl ether, 2-pyrrolidone, and glycerin were charged in the stated order while stirring the contents using the stirrer. Table 6 below shows the charge amount ratio of each raw materials.

TABLE 6

| Ink (I-1) | Charge amount [% by mass] |
|---|---|
| Pigment dispersion (D-1) | 40.0 |
| Nonionic polymeric surfactant (S-1) | 0.3 |
| Triethylene glycol mono-n-butyl ether | 4.0 |
| 2-Pyrrolidone | 5.0 |
| Glycerin | 20.0 |
| Water | Rest |
| Total | 100.0 |

### [Filling Liquid Preparation]

Filling liquids (F-1) to (F-6) were prepared by the following methods. Details of moisturizing agents (M-1) to (M-6) used in the filling liquid preparation is described first.

### [Moisturizing Agents (M-1) to (M-6)]

Compounds shown below in Table 7 were prepared by the following methods and were used as moisturizing agents (M-1) to (M-6). The viscosity of each moisturizing agent was measured using a falling ball viscometer (“LOVIS 2000”, product of Anton Paar Japan K.K.) at 25° C.

### [Preparation of Moisturizing Agents (M-2) to (M-6)]

Polyethylene glycol and glycerin were reacted at 200° C. for etherification. Thus, compounds used as the moisturizing agents (M-2) to (M-6) shown in Table 7 were synthesized. The resulting compounds were confirmed to have at least 99% of peaks of glycerin and polyethylene glycol by high performance liquid chromatography (HPLC). Specifically, the resulting compounds each were added to and mixed with acetonitrile and water, and then quantitatively analyzed by HPLC under the following conditions.
HPLC device: “HITACHI D-7000”, product of Hitachi High-Tech Science Corporation
Flow rate: 1.0 mL/min
Detector: “CORONA CAD DETECTOR”, product of ESA Biosciences (Conditions for Glycerin Analysis)
Column: “TSKGEL AMIDE-80”, product of Tosoh Corporation (5 m, 4.6×250 mm)
Solution: 50% by volume of acetonitrile/water (distilled water) (Conditions for Polyethylene Glycol Analysis)
Column: “INERTSIL C8-3”, product of GL Sciences Inc. (5 m, 4.6×150 mm)
Solution: acetonitrile/water (distilled water)

The volume rate of the acetonitrile in the solution was kept at 45% by volume for 3 minutes, and then a linear gradient was applied for 9 minutes until the volume rate of the acetonitrile increased from 45% by volume to 98% by volume. Thereafter, the volume rate of the acetonitrile was kept at 98% by volume.

### [Preparation of Moisturizing Agent (M-1)]

A compound as the moisturizing agent (M-1) shown in Table 7 was synthesized by the same method as that for synthesizing the moisturizing agents (M-2) to (M-6) except that ethylene glycol was used instead of polyethylene glycol. The resulting compound was confirmed to have at least 99% peaks of glycerin and polyethylene glycol using the same method as that for the moisturizing agents (M-2) to (M-6).

TABLE 7

| | Moisturizing agent | | | | | |
|---|---|---|---|---|---|---|
| | M-1 | M-2 | M-3 | M-4 | M-5 | M-6 |
| a + b + c | 3 | 6 | 9 | 15 | 18 | 21 |
| Viscosity [mPa · s] | 480 | 410 | 350 | 310 | 280 | 250 |

### [Preparation of Filling Liquid (F-1)]

A mixed liquid was obtained by mixing 30.0 parts by mass of the moisturizing agent (M-1), 0.2 parts by mass of “SURFYNOL (registered Japanese trademark) 420” (product of Nissin Chemical Industry Co., Ltd., an ethylene oxide adduct of acetylene glycol) being an acetylene glycol surfactant, and ion exchange water. The amount of ion exchange water added was adjusted so that the total mass of the mixed liquid reached 100.0 parts by mass. The mixed liquid was used as a filling liquid (F-1).

### [Preparation of Filling Liquids (F-2) to (F-6)]

Filling liquids (F-2) to (F-6) were prepared by the same method as that for preparing the filling liquid (F-1), except that the type and amount of each component were changed as shown in Table 8. Note that the surfactant B below in Table 8 refers to “SURFYNOL (registered Japanese trademark) 420” indicated as above.

TABLE 8

| | | Filling liquid | | | | | |
|---|---|---|---|---|---|---|---|
| | | F-1 | F-2 | F-3 | F-4 | F-5 | F-6 |
| Moisturizing | Type | M-1 | M-2 | M-3 | M-4 | M-5 | M-6 |
| agent | a + b + c | 3 | 6 | 9 | 15 | 18 | 21 |
| | Viscosity | 480 | 410 | 350 | 310 | 280 | 250 |
| | [mPa · s] | | | | | | |
| | Percentage | 30.0 | 30.0 | 30.0 | 30.0 | 30.0 | 30.0 |
| | content | | | | | | |
| | [% by mass] | | | | | | |
| Surfactant B | Percentage | 0.2 | 0.2 | 0.2 | 0.2 | 0.2 | 0.2 |
| | content | | | | | | |
| | [% by mass] | | | | | | |
| Water | Percentage | Rest | Rest | Rest | Rest | Rest | Rest |
| | content | | | | | | |
| | [% by mass] | | | | | | |

### [Preparation of Ink Set]

As shown below in Table 9, the ink (I-1) and any one of the filling liquids (F-1) to (F-6) were combined. Thus, ink sets for Examples 1 to 4 and Comparative Examples 1 and 2 were prepared.

### [Evaluation 1]

Each of the ink sets of Examples 1 to 4 and Comparative Examples 1 and 2 were evaluated for the following performances by the methods described below. The performances evaluated included: agglomeration inhibition performance of the inks in an open system (with evaporation) and a closed system (without evaporation), indicating the capability of inhibiting agglomeration of the pigment components in each ink; purge ability of the filling liquids, indicating whether the filling liquid can be purged after a recording head has been left unused; and introducibility of the filling liquids, indicating the property of the filling liquid to be easily introduced into the ink flow channel within the recording head. The evaluation results are shown below in Table 9.

### (Agglomeration Inhibition Performance in Open System)

In a beaker, 1.0 part by mass of the ink (ink (I-1) in Examination 1) was mixed with 50.0 parts by mass of the filling liquid (any of the filling liquids (F-1) to (F-6)), which were included in an ink set as an evaluation target. Next, the beaker containing the resulting mixed liquid was stored in a constant-temperature bath at 40° C. for one month without being sealed (storage treatment). The resulting mixed liquid after the treatment was analyzed for the presence or absence of agglomerate with a particle size of at least 3 m using a particle shape image analyzer (“FPIA (registered Japanese trademark)-3000”, product of Malvern Panalytical).

Note that a filling liquid, filled into the recording head after recording head inspection, mixes with an ink remaining in the recording head. The mixing ratio of the residual ink to the filling liquid (amount of ink/amount of filling liquid) varies depending on the location within the recording head, but it is expected to be around 1/50 at most. Therefore, the mixing ratio of the residual ink to the filling liquid was set to 1.0 part by mass of the ink to 50.0 parts by mass of the filling liquid. Agglomerate with a particle size of at least 3 m generated inside of the recording head may cause filter clogging, resulting in ink discharge failure. Therefore, generation of agglomerate with a particle size of at least 3 m after the storage treatment was considered as a criterion for determination of inhibition of ink agglomeration.

### (Agglomeration Inhibition Performance in Closed System)

Evaluation of “Agglomeration Inhibition Performance in Closed System” was conducted by the same method as that for evaluation of “Agglomeration Inhibition Performance in Open System” described above except for the following changes. In the evaluation of “Agglomeration Inhibition Performance in Closed System”, the beaker was sealed with parafilm during storage to inhibit evaporation. The evaluation of “Agglomeration Inhibition Performance in Closed Systems” is conducted under milder conditions compared to those in “Agglomeration Inhibition Performance in Open System” due to the absence of concentration of pigment components caused by solvent evaporation.

### (Criteria for Determining Agglomeration Inhibition Performance)

A (Pass): no agglomerate with a particle size of at least 3 m was generated through storage treatment in either open system or closed system.

B (Fail): agglomerate with a particle size of at least 3 m was generated through storage treatment in at least one of open system and closed system.

### (Purge Ability)

When a filling liquid is purged from a recording head that has been left in a high-temperature environment, the viscosity of the filling liquid around the nozzle increases due to evaporation of the water-soluble organic solvent and water in the filling liquid inside the recording head. Higher viscosity of the filling liquid increases the pressure (purge pressure) on the recording head during purging of the filling liquid, leading to damage to the recording head. The study conducted by the present disclosers reveals that the viscosity of a moisturizing agent at 25° C. being no greater than 450 mPa·s allows a filling liquid to be purged smoothly, without increasing the purge pressure or causing damage to the recording head. Therefore, whether the viscosity of the moisturizing agent at 25° C. is no greater than 450 mPa·s was considered as a criterion for determining purge ability of the filling liquid. Purge ability of the filling liquid indicates whether the filling liquid can be purged after the recording head has been left unused.

(Criteria for Determining Purge ability)
A (Pass): viscosity of moisturizing agent at 25° C. of no greater than 450 mPa·s
B (Fail): viscosity of moisturizing agent at 25° C. of greater than 450 mPa·s

### (Introducibility)

First, an ink was filled into an unused recording head (“KJ4B-QA”, product of KYOCERA Corporation, total number of nozzles: 2656) and ejected therefrom. The ink used was a cyan ink for the inkjet color production printer “TASKALFA PRO 15000c” produced by KYOCERA Document Solutions Japan Inc. Next, the recording head was washed with pure water and then completely dried. Next, 25 mL of the filling liquid (any of the filling liquids (F-1) to (F-6)), which was included in the ink set being an evaluation target, was filled into the recording head. Then, the filling liquid was expelled from the recording head by ejecting. This process was performed 10 times in total, with a total of 250 mL for filling. Then, the filling liquid was refilled into the recording head. Thereafter, a nozzle check pattern was printed on a glass plate using the recording head filled with the filling liquid. Thus, the nozzle check pattern was formed on the glass plate with the filling liquid. Next, the number of ejection nozzles that ejected the filling liquid (number of ejection nozzles) was counted by scanning the glass plate using a scanner. The rate [%] (introduction rate) of the number of ejection nozzles to the total number (2656) of the nozzles of the recording head was calculated using the following equation. Introductivity of the filling liquid was determined according to the following criteria.

Introduction rate=100×Number of ejection nozzles/Total number of nozzles

### (Criteria for Determining Introducibility)

A (Pass): introducibility of at least 90%
B (Fail): introducibility of less than 90%

TABLE 9

| | | | | | Comparative | |
|---|---|---|---|---|---|---|
| | Examples | | | | Examples | |
| | 1 | 2 | 3 | 4 | 1 | 2 |
| Type of ink | I-1 | I-1 | I-1 | I-1 | I-1 | I-1 |
| Type of filling liquid | F-2 | F-3 | F-4 | F-5 | F-1 | F-6 |
| Moisturizing agent's | 410 | 350 | 310 | 280 | 480 | 250 |
| viscosity [mPa · s] | | | | | | |
| Aggolomeratin | A | A | A | A | A | B |
| inhibition performanc | | | | | | |
| Purge ability | A | A | A | A | B | A |
| Introducibility | A | A | A | A | A | A |

As shown in Tables 1 to 9, it was revealed that a+b+c in general formula (1) of the moisturizing agent is preferably at least 4 and no greater than 20.

### [Examination 2: Mass Average Molecular Weight of Nonionic Polymeric Surfactant]

Next, the mass average molecular weight of the nonionic polymeric surfactant was examined. The following describes the preparation methods for each raw material used in ink production.

### (Nonionic Polymeric Surfactants (S-2) to (S-6))

As shown below in Table 10, copolymers with repeating units and mass average molecular weights different from those of the nonionic polymeric surfactant (S-1) were prepared and used as nonionic polymeric surfactants (S-2) to (S-6). The nonionic polymeric surfactants (S-2) to (S-6) were all soluble in water. Note that, in Table 10 below, “Repeating unit” column indicates inclusion of repeating units derived from corresponding monomers (polyethylene glycol methyl ether acrylate (PEGA), butyl acrylate (BA), polypropylene glycol methyl ether acrylate (PPGA), lauryl acrylate (LA), methyl methacrylate (MMA), ethyl acrylate (EA), and lauryl methacrylate (LMA)). Table 10 below shows the mass ratio of each repeating unit in a corresponding nonionic polymeric surfactant. It indicates that the polymeric nonionic surfactant (S-1), for example, includes: 60% of the repeating unit derived from PEGA; 10% of the repeating unit derived from BA; 10% of the repeating unit derived from PPGA; 12% of the repeating unit derived from LA; and 8% of the repeating unit derived from MMA.

TABLE 10

| | | | Mass | |
|---|---|---|---|---|
| Nonionic | | | average | |
| polymeric | Repeating unit | | molecular | |
| surfactant | Type | Mass ratio | weight | Solubility |
| S-1 | PEGA/BA/PPGA/LA/MMA | 60/10/10/12/8 | 8000 | Soluble |
| S-2 | PEGA/BA/PPGA/LA/MMA | 60/10/10/12/8 | 6000 | Soluble |
| S-3 | PEGA/BA/PPGA/LA/MMA | 60/10/10/12/8 | 7000 | Soluble |
| S-4 | PEGA/BA/PPGA/LA/MMA | 60/10/10/12/8 | 10000 | Soluble |
| S-5 | PEGA/BA/PPGA/LA/MMA | 60/10/10/12/8 | 11000 | Soluble |
| S-6 | PEGA/EA/PPGA/LMA/MMA | 60/10/10/12/8 | 7000 | Soluble |

### [Preparation of Inks (I-2) to (I-8)]

Inks (I-2) to (I-8) were prepared by the same method as that for preparing the ink (I-1), except that the type and amount of each raw material charged were as shown below in Table 11. Note that “BTG” below in Table 11 indicates triethylene glycol mono-n-butyl ether.

TABLE 11

| | | | Ink | | | | | | | |
|---|---|---|---|---|---|---|---|---|---|---|
| | | | I-1 | I-2 | I-3 | I-4 | I-5 | I-6 | I-7 | I-8 |
| Charge | Pigment | | 40.0 | 40.0 | 40.0 | 40.0 | 40.0 | 40.0 | 40.4 | 40.0 |
| amount | dispersion (D-1) | | | | | | | | | |
| [% by | Nonionic | (S-1) | 0.3 | — | — | — | — | — | 0.8 | — |
| mass] | polymeric | (S-2) | — | 0.3 | — | — | — | — | — | |
| | surfactant | (S-3) | — | — | 0.3 | — | — | — | — | |
| | | (S-4) | — | — | — | 0.3 | — | — | — | |
| | | (S-5) | — | — | — | — | 0.3 | — | — | |
| | | (S-6) | — | — | — | — | — | 0.3 | — | |

| | | | | | | | | |
|---|---|---|---|---|---|---|---|---|
| BTG | 4.0 | 4.0 | 4.0 | 4.0 | 4.0 | 4.0 | 4.0 | 4.0 |
| 2-Pyrrolidone | 5.0 | 5.0 | 5.0 | 5.0 | 5.0 | 5.0 | 5.0 | 5.0 |
| Glycerin | 20.0 | 20.0 | 20.0 | 20.0 | 20.0 | 20.0 | 20.0 | 20.0 |
| Water | Rest | Rest | Rest | Rest | Rest | Rest | Rest | Rest |
| Total | 100.0 | 100.0 | 100.0 | 100.0 | 100.0 | 100.0 | 100.0 | 100.0 |

### [Preparation of Filling Liquid (F-7)]

A filling liquid (F-7) was prepared by the same method as that for preparing the filling liquids (F-1) to (F-6), except that the type of moisturizing agent and the amounts of moisturizing agent and water were changed as shown in Table 12.

TABLE 12

| Filling liquid (F-7) | Percentage content [% by mass] |
|---|---|
| Moisturizing agent (M-2) | 35.0 |
| Surfactant B | 0.2 |
| Water | Rest |
| Total | 100.0 |

### [Preparation of Ink Sets]

Any one of the inks (I-1) to (I-8) was combined with the filling liquid (F-7) as show below n in Table 13. Thus, ink sets for Examples 5 to 9 and Comparative Examples 3 to 5 were prepared.

### [Evaluation 2]

Each of the ink sets of Examples 5 to 9 and Comparative Examples 3 to 5 were evaluated for agglomeration inhibition performance of each of the inks, the purge ability of each of the filling liquids, and introducibility of each of the filling liquids by the same methods as described in the former section [Evaluation 1]. The evaluation results are shown below in Table 13.

TABLE 13

| | | | | | | | | Comparative | | |
|---|---|---|---|---|---|---|---|---|---|---|
| | | | Examples | | | | | Examples | | |
| | | | 5 | 6 | 7 | 8 | 9 | 3 | 4 | 5 |
| Ink | Type of ink | | I-1 | I-3 | I-4 | I-6 | I-7 | I-2 | I-5 | I-8 |
| | Nonionic | Type | S-1 | S-3 | S-4 | S-6 | S-1 | S-2 | S-5 | — |
| | polymeric | Mw | 8000 | 7000 | 10000 | 7000 | 8000 | 6000 | 11000 | — |
| | surfactant | Percentage | 0.3 | 0.3 | 0.3 | 0.3 | 0.8 | 0.3 | 0.3 | — |
| | | content | | | | | | | | |
| | | [% by mass] | | | | | | | | |

| Type of filling liquid | | F-7 | F-7 | F-7 | F-7 | F-7 | F-7 | F-7 | F-7 |
|---|---|---|---|---|---|---|---|---|---|
| Evaluation | Agglomeration | A | A | A | A | A | B | B | B |
| | inhibition performance | | | | | | | | |
| | Purge ability | A | A | A | A | A | A | A | A |
| | Introducibility | A | A | A | A | A | A | A | B |

As shown in Tables 10 to 13, it was found that the ink, containing the nonionic polymeric surfactant, can effectively inhibit the pigment components of the ink from agglomerating during mixing with the filing liquid, thereby enabling the filling liquid to be introduced smoothly. Also as shown in Tables 10 to 13, it was found that dispersion stability cannot be ensured due to the mass average molecular weight of the nonionic polymeric surfactant being less than 6500 or greater than 10,500, resulting in generation of agglomerate with a particle size of at least 3 m after the storage treatment. By contrast, no agglomerate with a particle size of at least 3 m was observed after the storage treatment when the mass average molecular weight of the nonionic polymeric surfactant was at least 6500 and no greater than 10,500.

### [Examination 3: Types of Glycol Ether]

Next, the types of glycol ether were examined.

### [Preparation of Inks (I-9) to (I-13)]

Inks (I-9) to (I-13) were prepared by the same method as that for preparing the inks (I-1) to (I-8), except that the type and amount of each raw material charged were as shown below in Table 14. Note that, in Table 14 below, “BTG” refers to a triethylene glycol mono-n-butyl ether, “BDG” refers to diethylene glycol mono-n-butyl ether, “BEG” refers to ethylene glycol mono-n-butyl ether, and “iPDG” refers to diethylene glycol isopropyl ether.

TABLE 14

| | | | Ink | | | | |
|---|---|---|---|---|---|---|---|
| | | | I-9 | I-10 | I-11 | I-12 | I-13 |
| Charge | Pigment | | 40.0 | 40.0 | 40.0 | 40.0 | 40.0 |
| amount | dispersion (D-1) | | | | | | |
| [% by | Nonionic polymeric | | 0.3 | 0.3 | 0.3 | 0.3 | 0.3 |
| mass] | surfactant (S-1) | | | | | | |
| | Glycol | BTG | 4.0 | — | — | — | 2.0 |
| | ether | BDG | — | 4.0 | — | — | — |
| | | BEG | — | — | 4.0 | — | — |
| | | iPDG | — | — | — | 4.0 | — |

| | | | | | |
|---|---|---|---|---|---|
| 2-Pyrrolidone | 5.0 | 5.0 | 5.0 | 5.0 | 5.0 |
| Glycerin | 20.0 | 20.0 | 20.0 | 20.0 | 20.0 |
| Water | Rest | Rest | Rest | Rest | Rest |
| Total | 100.0 | 100.0 | 100.0 | 100.0 | 100.0 |

### [Preparation of Ink Sets]

Any one of the inks (I-9) to (I-12) was combined with the filling liquid (F-7) as shown below in Table 15. Thus, ink sets for Examples 10 to 12 and Comparative Examples 4 to 6 were prepared.

### [Evaluation 3]

Each of the ink sets of Examples 10 to 12 and Comparative Examples 4 to 6 were evaluated for agglomeration inhibition performance of each of the inks, purge ability of each of the filling liquids, and introducibility of each of the filling liquids by the same methods as described in the former section [Evaluation 1]. The evaluation results are show below n in Table 15.

TABLE 15

| | | | | | | Comparative | |
|---|---|---|---|---|---|---|---|
| | | | Examples | | | Examples | |
| | | | 10 | 11 | 12 | 4 | 6 |
| Ink | Type of ink | | I-9 | I-10 | I-13 | I-11 | I-12 |
| | Glycol | Type | BTG | BDG | BTG | BEG | iPDG |
| | ether | Percentage | 4.0 | 4.0 | 2.0 | 4.0 | 4.0 |
| | | content | | | | | |
| | | [% by mass] | | | | | |

| Type of filling liquid | | F-7 | F-7 | F-7 | F-7 | F-7 |
|---|---|---|---|---|---|---|
| Evaluation | Agglomeration | A | A | A | A | A |
| | inhibition performance | | | | | |
| | Purge ability | A | A | A | A | A |
| | Introducibility | A | A | A | B | B |

As shown in Tables 14 and 15, it was found that triethylene glycol mono-n-butyl ether and diethylene glycol mono-n-butyl ether can impart the filling liquid with favorable introducibility. The reason is considered to be that the specific glycol ether is highly hydrophobic and exhibits excellent wettability. By contrast, ethylene glycol mono-n-butyl ether exhibits higher hydrophilicity than the specific glycol ether due to having a smaller number of ether (—O—) groups. Diethylene glycol isopropyl ether exhibits higher hydrophilicity than the specific glycol ether due to having a shorter alkyl chain length than the specific glycol ether. Therefore, ethylene glycol mono-n-butyl ether and diethylene glycol isopropyl ether, which exhibit insufficient wettability, failed to sufficiently impart the filling liquid with introduibility.

### [Examination 4: Content of Moisturizing Agent in Filling Liquid]

Next, the moisturizing agent content in filling liquids was examined.

### [Preparation of Filling Liquids (F-8) and (F-9)]

Filling liquids (F-8) and (F-9) were prepared by the same method as that for preparing the filling liquids (F-1) to (F-6), except that the type and amount of each component were changed as shown below in Table 16. Note that a surfactant B in Table 16 refers to “SURFYNOL (registered Japanese trademark) 420” as described above.

TABLE 16

| | | |
|---|---|---|
| Filling liquid | F-8 | F-9 |

| | | | |
|---|---|---|---|
| Moisturizing agent | Type | M-2 | M-2 |
| | a + b + c | 6 | 6 |
| | Viscosity [mPa · s] | 410 | 410 |
| | Percentage content | 20.0 | 40.0 |
| | [% by mass] | | |
| Surfactant B | Percentage content | 0.2 | 0.2 |
| | [% by mass] | | |
| Water | Percentage content | Rest | Rest |
| | [% by mass] | | |

### [Preparation of Ink Sets]

Either one of the filling liquids (F-8) and (F-9) was combined with the ink (I-1) as shown below in Table 17. Thus, ink sets for Examples 13 and 14 were prepared.

### [Evaluation 4]

Each of the ink sets of Examples 13 and 14 were evaluated for agglomeration inhibition performance of each of the inks, the purge ability of each of the filling liquids, and introducibility of the filling liquids by the same methods as described in the former section [Evaluation 1]. The evaluation results are shown below in Table 17. Table 17 below also shows the evaluation results of the ink set of Example 1 for reference.

TABLE 17

| | | | Examples | | |
|---|---|---|---|---|---|
| | | | 1 | 13 | 14 |
| Type of ink | | | I-1 | I-1 | I-1 |
| Filling | Type of filling liquid | | F-2 | F-8 | F-9 |
| liquid | Moisturizing | Type of | M-2 | M-2 | M-2 |
| | agent | moisturizing | | | |
| | | agent | | | |
| | | Percentage content | 30.0 | 20.0 | 40.0 |
| | | [% by mass] | | | |

| | | | | |
|---|---|---|---|---|
| Evaluation | Agglomeration inhibition performance | A | A | A |
| | Purge ability | A | A | A |
| | Introducibility | A | A | A |

As shown in Tables 16 and 17, the evaluation results for agglomeration inhibition performance of the inks, the purge ability of the filling liquids, and introducibility of the filling liquids were good, regardless of whether the percentage content of the specific moisturizing agent was 20.0% by mass or 40% by mass in the filling liquid, similarly to those in Example 1.

What is claimed is:

1. An ink set comprising
an inkjet ink; and
a recording head filling liquid, wherein
the inkjet ink contains a pigment, a pigment coating resin, an aqueous medium, a nonionic polymeric surfactant, and a specific glycol ether,
the specific glycol ether is triethylene glycol monobutyl ether or diethylene glycol monobutyl ether,
the nonionic polymeric surfactant has a mass average molecular weight of at least 6500 and no greater than 10,500,
the recording head filling liquid contains a specific moisturizing agent and water, and
the specific moisturizing agent is a compound represented by general formula (1) below, 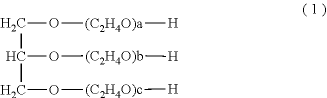
where in the general formula (1), a, b, and c each represent, independently of one another, an integer of at least 1 and a+b+c is at least 4 and no greater than 20.

2. The ink set according to claim 1, wherein
the nonionic polymeric surfactant has a percentage content of at least 0.2% by mass and no greater than 0.9% by mass in the inkjet ink.

3. The ink set according to claim 1, wherein
the specific glycol ether has a percentage content of at least 1.0% by mass and no greater than 6.0% by mass in the inkjet ink.

4. The ink set according to claim 1, wherein
the specific moisturizing agent has a percentage content of at least 16.0% by mass and no greater than 41.0% by mass in the recording head filling liquid.

5. The ink set according to claim 1, wherein
the specific moisturizing agent has a viscosity at 25° C. of at least 260 mPa·s and no greater than 450 mPa·s.

6. The ink set according to claim 1, wherein
the nonionic polymeric surfactant is a copolymer including a repeating unit derived from (meth)acrylic acid polyalkylene glycol alkyl ether, and a repeating unit derived from (meth)acrylic acid alkyl ester.

7. The ink set according to claim 6, wherein
the nonionic polymeric surfactant is
a copolymer including a repeating unit derived from polyethylene glycol methyl ether acrylate, a repeating unit derived from butyl acrylate, a repeating unit derived from polypropylene glycol methyl ether acrylate, a repeating unit derived from lauryl acrylate, and a repeating unit derived from methyl methacrylate, or
a copolymer including a repeating unit derived from polyethylene glycol methyl ether acrylate, a repeating unit derived from ethyl acrylate, a repeating unit derived from polypropylene glycol methyl ether acrylate, a repeating unit derived from lauryl methacrylate, and a repeating unit derived from methyl methacrylate.

8. The ink set according to claim 1, wherein
in the general formula (1), a+b+c is at least 6 and no greater than 18.

9. The ink set according to claim 1, wherein
the recording head filling liquid is used to fill a recording head with the inkjet ink remaining therein.

10. A recording head inspection method using the ink set according to claim 1, comprising:
inspecting ejection performance of a recording head; and
filling the recording head filling liquid into the recording head after the inspecting, wherein
in the inspecting, the ejection performance of the recording head is inspected by causing the recording head to eject the inkjet ink.

11. The recording head inspection method according to claim 10, wherein
the recording head is a line recording head.
